(19) United States
(12) Patent Application Publication
(10) Pub. No.: US 2014/0254554 A1
(43) Pub. Date: Sep. 11, 2014

(54) METHOD AND DEVICE FOR FORWARDING UPLINK DATA

(71) Applicant: HUAWEI TECHNOLOGIES CO., LTD., Shenzhen (CN)

(72) Inventors: Jing Liu, Shenzhen (CN); Yan Peng, Shenzhen (CN)

(73) Assignee: HUAWEI TECHNOLOGIES CO., LTD., Shenzhen (CN)

(21) Appl. No.: 14/280,321

(22) Filed: May 16, 2014

Related U.S. Application Data
(63) Continuation of application No. PCT/CN2012/084819, filed on Nov. 19, 2012.

(51) Int. Cl. H04W 36/16

(52) U.S. Cl. CPC H04W 36/165; H04W 72/0413
USPC 370/331

(57) ABSTRACT

Embodiments of the present invention disclose methods and related devices for forwarding uplink data, which are used for avoiding the resource waste caused by the repeated transmission of the uplink data on a Un interface in a handover scenario where the target node is a relay node (RN). An method provided in the embodiments of the present invention includes: receiving, by a donor base station with a relay node RN attached thereto, uplink data sent by a user equipment (UE), wherein the RN is a target node in handover; performing, by the donor base station, a handover preparation; sending, by the donor base station, a serial number status transfer message to the RN; and sending the received uplink data sent by the UE to a serving-gateway S-GW.

### CROSS-REFERENCE TO RELATED APPLICATIONS

This application is a continuation of International Application No. PCT/CN2012/084819, filed on Nov. 19, 2012, which claims priority to Chinese Patent Application No. 201110369380.2, filed on Nov. 18, 2011, both of which are hereby incorporated by reference in their entireties.

### TECHNICAL FIELD

The present invention relates to the field of communications, and particularly, to methods and devices for forwarding uplink data.

### BACKGROUND

In a release 8 (Rel-8) system of a long term evolution (LTE), when a user equipment (UE) moves at an edge of a cell, the UE needs to perform a handover operation in order to ensure continuity of services. The existing Rel-8 system has two handover scenarios: X2 handover and S1 handover.

A relay node (RN) is introduced into a release 10 (Rel-10) system of the LTE, the RN and a donor base station (DeNB) with the RN attached thereto have an S1 interface relation and an X2 interface relation, and the DeNB will provide an S1/X2 agent function between the RN and an another network node (such as an evolved NodeB (eNB), a mobility management entity (MME) or a serving-gateway (S-GW)). That is to say, a GPRS Tunneling Protocol (GTP) tunnel for a data transmission of a S1 user plane is established between the RN and the DeNB and between the DeNB and the S-GW, respectively; and a GTP tunnel for a data transmission of a X2 user plane is established between the RN and the DeNB and between the DeNB and an another eNB, respectively.

After the RN is introduced, in a handover process using the RN as a target node and a process of forwarding uplink data, the same uplink data will be transmitted back and forth on a Un interface between the DeNB and the RN to cause resource waste of a Un air interface. The reader may be further referred to publication 3GPP TS 36.300 V10.0.0, section 4.7.1 for the definition of the Un interface and other terminologies.

### SUMMARY

Methods and related devices for forwarding uplink data are provided in the embodiments of the present invention, which are used for avoiding the resource waste caused by the repeated transmission of the uplink data on a Un interface in a handover scenario where the target node is an RN.

A method for forwarding uplink data is provided in the present invention. A DeNB with a relay node RN attached thereto receives uplink data sent by a user equipment, wherein the RN is a target node in handover. The DeNB performs a handover preparation. The DeNB sends a serial number status transfer message to the RN and sends the received uplink data sent by the user equipment to a serving-gateway S-GW.

Alternatively, in the handover preparation, the DeNB sends a handover request message to the RN, wherein the handover request carries a first information element IE identity, and the first IE identity is used for indicating that the RN does not need to allocate an uplink data forwarding tunnel identity.

Alternatively, in the handover preparation, the DeNB receives a handover request acknowledge message sent by the RN, wherein the handover request acknowledge message carries a second IE identity, and the second IE identity is used for indicating a decision by the donor evolved NodeB that whether a source node is needed to forward the uplink data.

Alternatively, in the handover preparation, the DeNB sends a handover request message to the RN, wherein the handover request message carries an uplink forwarding not possible parameter of a radio access bearer of the UE, and the uplink forwarding not possible parameter is used for indicating that the RN does not need to forward the uplink data of the radio access bearer.

Alternatively, in the handover preparation, the DeNB receives a handover request acknowledge message sent by the target node RN. The DeNB re-decides which radio access bearer RAB of the user equipment needs a forwarding of the uplink data, no matter whether the handover request acknowledge message carries an uplink data forwarding tunnel identity allocated by the RN; and reallocates a corresponding uplink data forwarding tunnel identity to the RAB needing a forwarding of the uplink data.

Alternatively, in the handover preparation, the DeNB receives the handover request acknowledge message sent by the target node RN. If the handover request acknowledge message carries an uplink data forwarding tunnel identity corresponding to a RAB of the UE, the DeNB modifies the uplink data forwarding tunnel identity into an uplink data forwarding tunnel identity allocated by the DeNB.

A donor base station provided in the present invention includes: a data receiving unit, configured to receive uplink data sent by a user equipment, wherein the RN is a target node in handover; a handover preparation unit, configured to perform a handover preparation of a base station; a transfer message sending unit, configured to send a serial number status transfer message to the RN; and a data sending unit, configured to send the received uplink data sent by the user equipment to a serving-gateway after the RN sends the serial number status transfer message.

Alternatively, the handover preparation unit includes: a first request sending module, configured to send a handover request message to the RN, wherein the handover request carries a first IE identity, and the first IE identity is used for indicating that the RN does not need to allocate an uplink data forwarding tunnel identity.

Alternatively, the handover preparation unit further includes: a request acknowledge receiving module, configured to receive a handover request acknowledge message returned by the RN, wherein the handover request acknowledge message carries a second IE identity, and the second IE identity is used for indicating a decision by the donor evolved NodeB that whether a source node is needed to forward the uplink data.

Alternatively, the handover preparation unit further includes: a second request sending module, configured to send a handover request message to the RN, wherein the handover request message carries an uplink forwarding not possible parameter of a radio access bearer of the user equipment, and the uplink forwarding not possible parameter is used for indicating that the RN does not need to forward the uplink data of the radio access bearer.

Alternatively, the handover preparation unit also includes: an identity allocating module, configured to re-decide which RAB of the user equipment needs a forwarding of the uplink data no matter whether the handover request acknowledge message carries an uplink data forwarding tunnel identity allocated by the RN, after the handover request acknowledge message sent by the target node RN is received, and reallocate a corresponding uplink data forwarding tunnel identity to the RAB needing a forwarding of the uplink data.

Alternatively, the request acknowledge receiving module is further configured to detect whether the handover request acknowledge message carries the uplink data forwarding tunnel identity corresponding to the RAB of the user equipment after the handover request acknowledge message sent by the target node RN is received and trigger an identity modifying module if the handover request acknowledge message carries the uplink data forwarding tunnel identity; the handover preparation unit further includes: the identity modifying module, configured to, if the handover request acknowledge message carries the uplink data forwarding tunnel identity corresponding to the RAB of the user equipment, modify the uplink data forwarding tunnel identity into the allocated uplink data forwarding tunnel identity.

From the above technical solution, the embodiments of the present invention have the following advantages: in the handover scenario where the target node is the RN, after the DeNB with the target node attached thereto determines that the target node in handover is the RN and sends the SN status transfer message to the target node, the DeNB directly sends the received uplink data to the S-GW, rather than forwarding the received uplink data to the target node, thus avoiding repeated transmission of the uplink data on a Un interface between the DeNB and the target node and saving resource overhead of an air interface.

### BRIEF DESCRIPTION OF DRAWINGS

FIG. 1 is a flow schematic diagram illustrating a method for forwarding uplink data provided in an embodiment of the present invention;

FIG. 2 is another flow schematic diagram illustrating a method for forwarding uplink data provided in an embodiment of the present invention;

FIG. 3 is another flow schematic diagram illustrating a method for forwarding uplink data provided in an embodiment of the present invention;

FIG. 4 is a structure schematic diagram illustrating a DeNB provided in an embodiment of the present invention.

### DESCRIPTION OF EMBODIMENTS

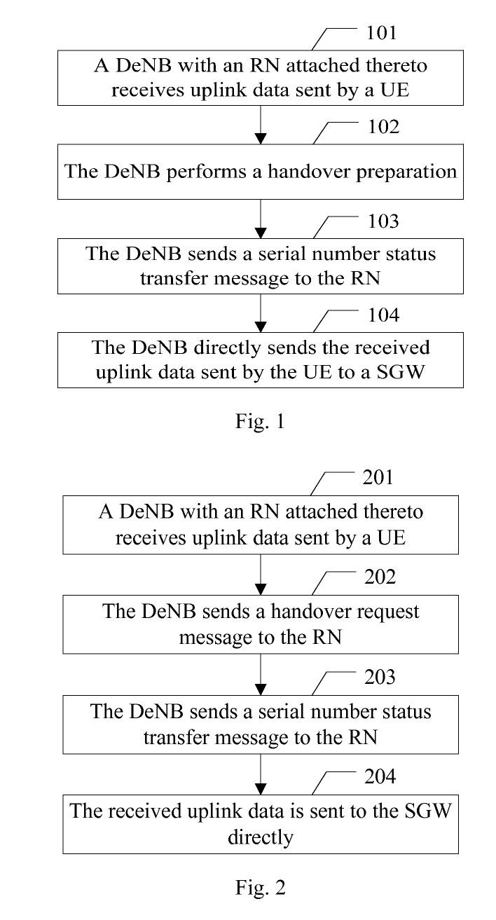

Methods and devices for forwarding uplink data are provided in the embodiments of the present invention, which are used for avoiding resource waste caused by repeated transmission of the uplink data on a Un interface during handover when the target node is an RN. Please refer to FIG. 1. One embodiment of the method for forwarding uplink data provided in the embodiments of the present invention includes:

101, receiving, by a DeNB with an RN attached thereto, uplink data sent by a UE;

the DeNB may receive the uplink data sent by the UE before a handover, and the uplink data may be directly sent to the DeNB by the UE or forwarded to the DeNB through other eNB by the UE.

102, performing, by the DeNB, a handover preparation;

the DeNB knows that the target node in handover is the RN attached to the DeNB, and may send a handover request message to the RN and receive a handover request acknowledge message returned by the RN.

103, sending, by the DeNB, a serial number status transfer message to the RN;

the DeNB sends the serial number (SN) status transfer message to the RN; and the SN status transfer message may be used for transferring receiving status information of the uplink data sent by the UE in a source node in handover to the RN.

104, directly sending, by the DeNB, the received uplink data sent by the UE to a serving-gateway.

After the DeNB sends the SN status transfer message to the RN, the DeNB directly sends the uplink data received from the UE to the S-GW.

Since the DeNB knows that the target node in handover is the RN attached to the DeNB, the DeNB ignores the constraint of stopping sending the uplink data to the S-GW in the prior art, does not forward the cached uplink data to the RN and directly sends the cached uplink data to the S-GW, and thus avoiding the resource waste caused by the repeated transmission of the uplink data between the DeNB and the RN.

The methods for forwarding uplink data provided in the present invention may be applied to an Intra-eNB handover scenario and an Inter-eNB handover scenario.

In the Intra-eNB handover scenario where the target node is the RN: the source node may be the DeNB, and after the DeNB instructs the UE to perform handover, the DeNB sends the SN status transfer message to the RN. Or, the source node may also be other RN attached to the DeNB; after the RN serving as the source node instructs the UE to perform handover, the RN serving as the source node sends the SN status transfer message to the DeNB; and after the DeNB receives the SN status transfer message, the DeNB may transfer the SN status transfer message to the target node RN.

If the source node is the DeNB, before the UE performs handover, the DeNB sends the uplink data sent by the UE to the S-GW, and the uplink data may be a service data unit (SDU) of an uplink packet data convergence protocol (PDCP). If the source node is another RN attached to the DeNB, before the UE performs handover, the DeNB sends the uplink data received from the source node to the S-GW. After the DeNB sends the SN status transfer message to the target node, since the DeNB knows that the target node in handover is the RN attached to the DeNB, at this moment, the DeNB continuously sends the received uplink data to the S-GW and does not forward the uplink data to the target node.

In the Inter-eNB handover scenario where the target node is the RN, when the source node instructs the UE to perform handover, the source node may send the SN status transfer message; and after the DeNB with the target node RN attached thereto receives the SN status transfer message, the DeNB may transfer the SN status transfer message to the target node RN. Wherein, the source node may be an eNB, a neighboring DeNB or an RN attached to the neighboring DeNB.

After the source node instructs the UE to perform handover, the source node sends the SN status transfer message; and after the DeNB with the target node RN attached thereto receives the SN status transfer message, the DeNB sends the SN status transfer message to the target node RN. After the DeNB with the target node RN attached thereto sends the SN status transfer message to the target node RN, since the DeNB knows that the target node in handover is the RN attached to the DeNB, the DeNB directly sends the uplink data received from the source node to the S-GW and does not send the uplink data received from the source node to the target node RN.

In the embodiment of the present invention, since the DeNB knows that the target node in handover is the RN attached to the DeNB, after the DeNB sends the SN status transfer message to the RN, even if the RN sends an uplink data forwarding tunnel identity (the uplink data forwarding tunnel identity is used for indicating a channel used for forwarding the uplink data) to the DeNB in the handover preparation process, the DeNB also ignores the received uplink data forwarding tunnel identity, does not establish an uplink data forwarding tunnel from the DeNB to the RN and directly sends the received uplink data to the S-GW, thus saving overhead of the repeated transmission of the uplink data between the DeNB and the RN. Wherein, the uplink data forwarding tunnel identity may be a tunnel endpoint identity (TEID) of an uplink general packet radio service (GPRS) tunnel protocol (UL GTP) in an X2 handover scenario or a UL transport layer address and a UL GTP TEID in an S1 handover scenario.

Alternatively, in the Inter-eNB handover scenario where the target node is the RN, after the DeNB with the target node attached thereto receives a handover request acknowledge message returned by the target node, the DeNB modifies the uplink data forwarding tunnel identity carried in the handover request acknowledge message, namely modifies the carried uplink data forwarding tunnel identity allocated by the target node into an uplink data forwarding tunnel identity allocated by the DeNB. In the case of the X2 handover scenario, the updated handover request acknowledge message is directly sent to the source node; in the case of the S1 handover scenario, the updated handover request acknowledge message is sent to an MME, and the MME forwards the handover request acknowledge message to the source node, so that the source node sends the uplink data according to the uplink data forwarding tunnel identity allocated by the DeNB.

In the embodiment of the present invention, the uplink data forwarding tunnel identity allocated by the DeNB and the uplink data forwarding tunnel identity allocated by the target node RN are different, wherein the uplink data forwarding tunnel identity allocated by the target node RN is used for forwarding the uplink data from the DeNB to the target node RN and establishing a forwarding tunnel from the DeNB to the target node RN; alternatively, the uplink data forwarding tunnel identity allocated by the DeNB is used for forwarding the uplink data from the source node to the DeNB and establishing a forwarding tunnel directly from the source node to the DeNB (aiming at a direct data forwarding mode in the S1 handover scenario or the X2 handover scenario), or forwarding the uplink data from the S-GW to the DeNB and establishing a forwarding tunnel from the S-GW to the DeNB (aiming at an indirect data forwarding mode in the S1 handover scenario).

Please refer to FIG. 2. An embodiment of the present invention provides another method for forwarding uplink data, including:

201, receiving, by a DeNB with an RN attached thereto, uplink data sent by a UE;

for contents of the step 201 in this embodiment, the contents of the step 101 in the embodiment shown in FIG. 1 can be referred to, and repetition is not given herein.

202, sending, by the DeNB, a handover request message to the RN;

the DeNB sends the handover request message to the target node RN, the handover request message carries a first information element (IE) identity, and the first IE identity is used for indicating that the target node RN does not need to allocate an uplink data forwarding tunnel identity. So, a handover request acknowledge message returned from the target node RN to the DeNB does not carry any uplink data forwarding tunnel identity.

Or, the DeNB with the target node attached thereto sends the handover request message to the target node RN, the handover request message includes a uplink forwarding not possible (UL forwarding not possible) parameter, and the UL forwarding not possible parameter is used for indicating that the target node RN does not need to forward the uplink data of which radio access bearer (RAB); and after the target node RN receives this parameter, the RN knows that an uplink data forwarding tunnel identity does not need to be allocated to the uplink data of which RAB. The UL forwarding not possible parameter is similar to the definition of a Data forwarding not possible parameter of the handover request message in the S1 handover scenario, except that the Data forwarding not possible parameter included in S1 handover signaling indicates that the uplink and downlink data of which RAB of the UE does not need to be forwarded, and the newly added UL forwarding not possible parameter merely indicates that the uplink data of which RAB of the UE does not need to be forwarded.

If the scenario of the embodiment of the present invention is an X2 handover scenario, the handover request message uses a signaling structure of an X2 interface; and if the scenario of the embodiment of the present invention is an S1 handover scenario, the handover request message uses a signaling structure of an S1 interface.

Since the target node RN in the embodiment of the present invention does not allocate the uplink data forwarding tunnel identity, the DeNB with the target node attached thereto does not receive the uplink data forwarding tunnel identity allocated by the target node RN in the handover performance process, so that the operation of ignoring forwarding the uplink data to the target node RN does not need to be performed, and resources of an air interface are saved.

In the Inter-eNB handover scenario where the target node is the RN, although the handover request acknowledge message received from the target node RN by the DeNB with the target node attached thereto does not carry the uplink data forwarding tunnel identity allocated by the target node RN in the embodiment of the present invention, the handover request acknowledge message returned from the DeNB to an MME needs to carry the uplink data forwarding tunnel identity allocated by the DeNB. Further, in this scenario, if data are forwarded in a direct forwarding mode, a handover command message received by a source node carries an uplink data forwarding tunnel identity allocated by the DeNB side, so as to establish an uplink data forwarding tunnel from the source node to the DeNB; if data are forwarded in an indirect forwarding mode, the handover command message received by the source node carries an uplink data forwarding tunnel identity allocated by an S-GW side, so as to establish an uplink data forwarding tunnel from the source node to the S-GW.

In the uplink data forwarding process, it should be noted that, the uplink data forwarding tunnel identity allocated by the DeNB and the uplink data forwarding tunnel identity allocated by the target node RN are different, wherein the uplink data forwarding tunnel identity allocated by the target node RN is used for forwarding the uplink data from the DeNB to the target node RN and establishing a forwarding tunnel from the DeNB to the target node RN; and the uplink data forwarding tunnel identity allocated by the DeNB is used for forwarding the uplink data from the source node to the DeNB and establishing a forwarding tunnel directly from the source node to the DeNB (aiming at a direct data forwarding mode), or forwarding the uplink data from the S-GW to the DeNB and establishing a forwarding tunnel from the S-GW to the DeNB (aiming at an indirect data forwarding mode).

203, sending, by the DeNB, an SN status transfer message to the RN;

the DeNB sends the SN status transfer message to the RN; and the SN status transfer message may be used for transferring receiving status information of the uplink data sent by the UE in the source node in handover to the RN.

204, directly sending the received uplink data to the S-GW.

After the DeNB sends the SN status transfer message to the RN, the DeNB directly sends the uplink data received from the UE to the S-GW.

Since the DeNB knows that the target node in handover is the RN attached to the DeNB, the DeNB will ignore the constraint of stopping sending the uplink data to the S-GW in the prior art, does not forward the cached uplink data to the RN and directly sends the cached uplink data to the S-GW, and thus avoiding the resource waste caused by the repeated transmission of the uplink data between the DeNB and the RN.

The method for forwarding uplink data in the present invention may be applied to an Intra-eNB handover scenario and an Inter-eNB handover scenario.

In the Intra-eNB handover scenario where the target node is the RN: the source node may be the DeNB, and after the DeNB instructs the UE to perform handover, the DeNB sends the SN status transfer message to the RN. Or, the source node may also be other RN attached to the DeNB; after the RN serving as the source node instructs the UE to perform handover, the RN serving as the source node sends the SN status transfer message to the DeNB; and after the DeNB receives the SN status transfer message, the DeNB may transfer the SN status transfer message to the target node RN.

If the source node is the DeNB, before the UE performs handover, the DeNB sends the uplink data sent by the UE to the S-GW, and the uplink data may be a service data unit (SDU) of an uplink packet data convergence protocol (PDCP). If the source node is another RN attached to the DeNB, before the UE performs handover, the DeNB sends the uplink data received from the source node to the S-GW. After the DeNB sends the SN status transfer message to the target node, since the DeNB knows that the target node in handover is the RN attached to the DeNB, at this moment, the DeNB continuously sends the received uplink data to the S-GW and does not forward the uplink data to the target node.

In the Inter-eNB handover scenario where the target node is the RN, when the source node instructs the UE to perform handover, the source node may send the SN status transfer message; and after the DeNB with the target node RN attached thereto receives the SN status transfer message, the DeNB may transfer the SN status transfer message to the target node RN. Wherein, the source node may be an eNB, a neighboring DeNB or an RN attached to the neighboring DeNB.

After the source node instructs the UE to perform handover, the source node sends the SN status transfer message; and after the DeNB with the target node RN attached thereto receives the SN status transfer message, the DeNB sends the SN status transfer message to the target node RN. After the DeNB with the target node RN attached thereto sends the SN status transfer message to the target node RN, since the DeNB knows that the target node in handover is the RN attached to the DeNB, the DeNB directly sends the uplink data received from the source node to the S-GW and does not send the uplink data received from the source node to the target node RN.

In the embodiment of the present invention, since the DeNB knows that the target node in handover is the RN attached to the DeNB, after the DeNB sends the SN status transfer message to the RN, even if the RN sends an uplink data forwarding tunnel identity (the uplink data forwarding tunnel identity is used for indicating a channel used for forwarding the uplink data) to the DeNB in the handover preparation process, the DeNB also ignores the received uplink data forwarding tunnel identity, does not establish an uplink data forwarding tunnel from the DeNB to the RN and directly sends the received uplink data to the S-GW, thus saving overhead of the repeated transmission of the uplink data between the DeNB and the RN. Wherein, the uplink data forwarding tunnel identity may be a tunnel endpoint identity (TEID) of an uplink general packet radio service (GPRS) tunnel protocol (UL GTP) in an X2 handover scenario or a UL transport layer address and a UL GTP TEID in an S1 handover scenario.

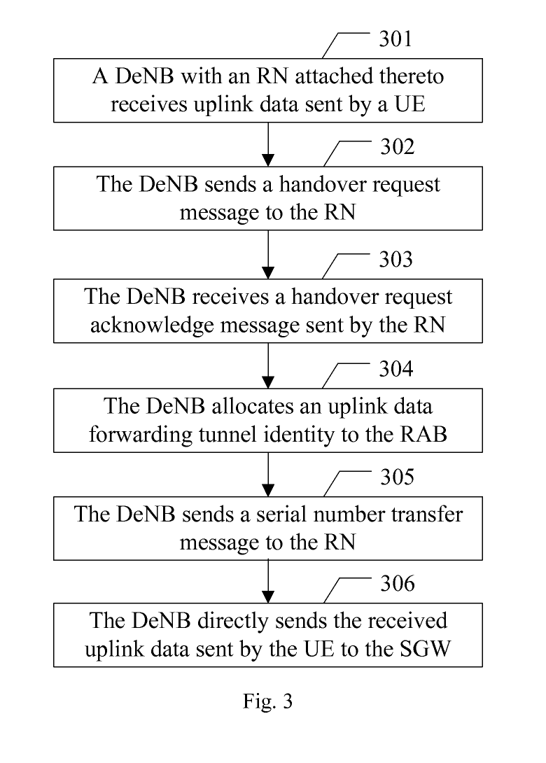

Besides the method provided in the embodiment shown in FIG. 2 above, the present invention may also optimize uplink data forwarding in the handover scenario where the target node is the RN through other methods. Please refer to FIG. 3. A further embodiment of the method for forwarding uplink data provided in the embodiments of the present invention includes:

301, receiving, by a DeNB with an RN attached thereto, uplink data sent by a UE;

for contents of the step 301 in this embodiment, the contents of the step 101 in the embodiment shown in FIG. 1 can be referred to, and repetition is not given herein.

302, sending, by the DeNB, a handover request message to the RN;

the DeNB sends the handover request message to the RN, and the handover request message does not carry a first IE identity or a UL forwarding not possible parameter.

303, receiving, by the DeNB, a handover request acknowledge message sent by the RN;

after the target node RN receives the handover request message sent by the DeNB and the RN determines itself as the target node in handover, the RN does not allocate an uplink data forwarding tunnel identity. When the target node RN returns the handover request acknowledge message to the DeNB, the handover request acknowledge message does not carry any uplink data forwarding tunnel identity but carries a second IE identity, and the second IE identity is used for indicating a decision by the donor evolved NodeB that whether a source node is needed to forward the uplink data, namely decide that the uplink data of which RAB needs to be forwarded and allocate an uplink data forwarding tunnel identity to the RAB.

304, allocating, by the DeNB, an uplink data forwarding tunnel identity to the RAB;

after the DeNB receives the handover request acknowledge message returned by the target node RN, the DeNB decides that the uplink data corresponding to which RAB need to be forwarded according to the indication of the above-mentioned second IE identity, and allocates an corresponding uplink data forwarding tunnel identity (the uplink data forwarding tunnel identity may be a UL GTP TEID in the X2 handover scenario or a UL transport layer address and a UL GTP-TEID in the S1 handover scenario) to the RAB.

Alternatively, the DeNB may actively decide the allocation of an uplink data forwarding tunnel identity, at this moment, the handover request message sent from the target node RN to the DeNB may not carry the above-mentioned second IE identity; specifically, after the DeNB receives the handover request acknowledge message sent by the target node RN, no matter whether the handover request acknowledge message carries the uplink data forwarding tunnel identity allocated by the target node RN, the DeNB re-decides that the uplink data of which RAB of the UE needs to be forwarded and reallocates a corresponding uplink data forwarding tunnel identity to the RAB needing forwarding of the uplink data.

It should be noted that, the uplink data forwarding tunnel identity allocated by the DeNB is different from the uplink data forwarding tunnel identity allocated by the target node RN in the prior art, wherein the uplink data forwarding tunnel identity allocated by the target node RN is used for forwarding the uplink data from the DeNB to the target node RN and establishing a forwarding tunnel from the DeNB to the target node RN. The uplink data forwarding tunnel identity allocated by the DeNB is used for forwarding the uplink data from the source node to the DeNB and establishing a forwarding tunnel directly from the source node to the DeNB (aiming at a direct data forwarding mode), or forwarding the uplink data from an S-GW to the DeNB and establishing a forwarding tunnel from the S-GW to the DeNB (aiming at an indirect data forwarding mode).

305, sending, by the DeNB, an SN status transfer message to the RN;

the DeNB sends the SN status transfer message to the RN; and the SN status transfer message may be used for transferring receiving status information of the uplink data sent by the UE in the source node of handover to the RN.

306, directly sending, by the DeNB, the received uplink data sent by the UE to the S-GW.

After the DeNB sends the SN status transfer message to the RN, the DeNB directly sends the uplink data received from the UE to the S-GW.

Since the DeNB knows that the target node in handover is the RN attached to the DeNB, the DeNB ignores the constraint of stopping sending the uplink data to the S-GW in the prior art, does not forward the cached uplink data to the RN and directly sends the cached uplink data to the S-GW, and thus avoiding the resource waste caused by the repeated transmission of the uplink data between the DeNB and the RN.

The method for forwarding uplink data in the present invention may be applied to an Intra-eNB handover scenario and an Inter-eNB handover scenario.

In the Intra-eNB handover scenario where the target node is the RN: the source node may be the DeNB, and after the DeNB instructs the UE to perform handover, the DeNB sends the SN status transfer message to the RN. Or, the source node may also be other RN attached to the DeNB; after the RN serving as the source node instructs the UE to perform handover, the RN serving as the source node sends the SN status transfer message to the DeNB; and after the DeNB receives the SN status transfer message, the DeNB may transfer the SN status transfer message to the target node RN.

If the source node is the DeNB, before the UE performs handover, the DeNB sends the uplink data sent by the UE to the S-GW, and the uplink data may be a service data unit (SDU) of an uplink packet data convergence protocol (PDCP). If the source node is another RN attached to the DeNB, before the UE performs handover, the DeNB sends the uplink data received from the source node to the S-GW. After the DeNB sends the SN status transfer message to the target node, since the DeNB knows that the target node in handover is the RN attached to the DeNB, at this moment, the DeNB continuously sends the received uplink data to the S-GW and does not forward the uplink data to the target node.

In the Inter-eNB handover scenario where the target node is the RN, when the source node instructs the UE to perform handover, the source node may send the SN status transfer message; and after the DeNB with the target node RN attached thereto receives the SN status transfer message, the DeNB may transfer the SN status transfer message to the target node RN. Wherein, the source node may be an eNB, a neighboring DeNB or an RN attached to the neighboring DeNB.

After the source node instructs the UE to perform handover, the source node sends the SN status transfer message; and after the DeNB with the target node RN attached thereto receives the SN status transfer message, the DeNB sends the SN status transfer message to the target node RN. After the DeNB with the target node RN attached thereto sends the SN status transfer message to the target node RN, since the DeNB knows that the target node in handover is the RN attached to the DeNB, the DeNB directly sends the uplink data received from the source node to the S-GW and does not send the uplink data received from the source node to the target node RN.

In the embodiment of the present invention, since the DeNB knows that the target node in handover is the RN attached to the DeNB, after the DeNB sends the SN status transfer message to the RN, even if the RN sends an uplink data forwarding tunnel identity (the uplink data forwarding tunnel identity is used for indicating a channel used for forwarding the uplink data) to the DeNB in the handover preparation process, the DeNB also ignores the received uplink data forwarding tunnel identity, does not establish an uplink data forwarding tunnel from the DeNB to the RN and directly sends the received uplink data to the S-GW, thus saving overhead of the repeated transmission of the uplink data between the DeNB and the RN. Wherein, the uplink data forwarding tunnel identity may be a tunnel endpoint identity (TEID) of an uplink general packet radio service (GPRS) tunnel protocol (UL GTP) in an X2 handover scenario or a UL transport layer address and a UL GTP TEID in an S1 handover scenario.

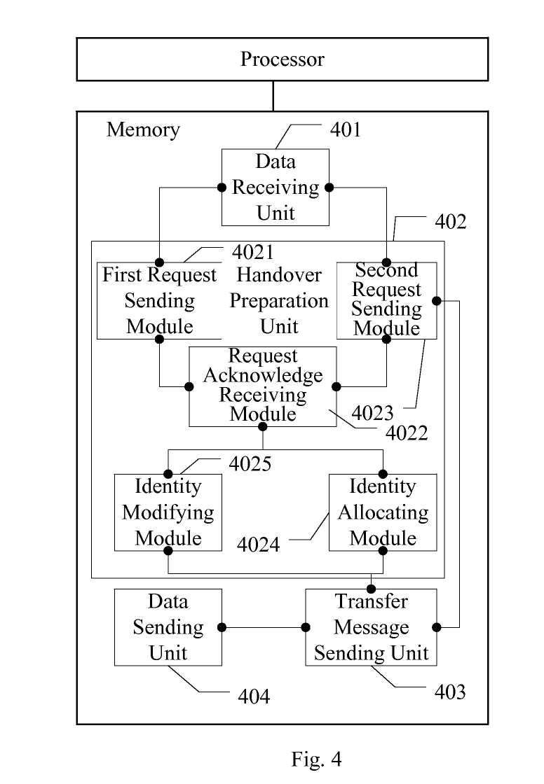

Embodiments of a DeNB for performing the above-mentioned methods for forwarding uplink data in the present invention are illustrated below. For a structure of the DeNB, please refer to FIG. 4. An embodiment of the DeNB provided in the embodiment of the present invention includes:

a data receiving unit 401, configured to receive uplink data sent by a user equipment, wherein a RN is a target node in handover;

a handover preparation unit 402, configured to perform a handover preparation;

a transfer message sending unit 403, configured to send a serial number status transfer message to the RN;

a data sending unit 404, configured to send the received uplink data sent by the user equipment to a serving-gateway after the RN sends the serial number status transfer message.

Alternatively, the handover preparation unit 402 provided in the embodiment of the present invention may include: a first request sending module 4021, configured to send a handover request message to the RN, wherein the handover request carries a first information element IE identity, and the first 1E identity is used for indicating that the RN does not need to allocate an uplink data forwarding tunnel identity.

Or, the handover preparation unit 402 may further include: a request acknowledge receiving module 4022, configured to receive a handover request acknowledge message returned by the RN, wherein the handover request acknowledge message carries a second IE identity, and the second IE identity is used for indicating a decision by the donor evolved NodeB that whether a source node is needed to forward the uplink data.

Or, the handover preparation unit 402 may further include: a second request sending module 4023, configured to send a handover request message to the RN, wherein the handover request message carries an uplink forwarding not possible parameter of a radio access bearer of the UE, and the uplink forwarding not possible parameter is used for indicating that the RN does not need to forward the uplink data of the radio access bearer.

Or, the handover preparation unit 402 may further include: an identity allocating module 4024, configured to re-decide which RAB of the UE needs a forwarding of the uplink data no matter whether the handover request acknowledge message carries an uplink data forwarding tunnel identity allocated by the RN, after the handover request acknowledge message sent by the target node RN is received, and reallocate a corresponding uplink data forwarding tunnel identity to the RAB needing a forwarding of the uplink data.

The request acknowledge receiving module 4022 is further configured to detect whether the handover request acknowledge message carries the uplink data forwarding tunnel identity corresponding to the RAB of the UE after the handover request acknowledge message sent by the target node RN is received, and trigger an identity modifying module 4025 if the handover request acknowledge message carries the uplink data forwarding tunnel identity; the identity modifying module 4025 is configured to, if the handover request acknowledge message carries the uplink data forwarding tunnel identity corresponding to the RAB of the UE, modify the uplink data forwarding tunnel identity into the allocated uplink data forwarding tunnel identity one by one.

The specific operation process of each unit of the DeNB provided in the embodiment of the present invention is as follows:

the data receiving unit 401 of the DeNB may receive the uplink data sent by the UE before handover, and the uplink data may be directly sent to the DeNB by the UE or forwarded to the DeNB through other eNB by the UE.

After the DeNB receives an instruction for handover of the base station, the handover preparation unit 402 of the DeNB performs a handover preparation of the base station. In order to avoid a repeated transmission of the uplink data on a Un interface between the DeNB and the target node, the following several methods may be used, specifically:

I, a handover request message may be sent to the target node RN by the first request sending module 4021 of the handover preparation unit 402, the handover request message carries a first information element (IE) identity, and the first IE identity is used for indicating that the target node RN does not need to allocate an uplink data forwarding tunnel identity. So, a handover request acknowledge message returned from the target node RN to the DeNB does not carry any uplink data forwarding tunnel identity. Therefore, the handover request acknowledge message received by the request acknowledge receiving module 4022 does not carry any uplink data forwarding tunnel identity, so that the operation of ignoring the forwarding the uplink data to the target node RN does not need to be performed, and resources of an air interface are saved.

II, alternatively, a handover request message may also be sent to the target node RN by the second request sending module 4023 of the handover preparation unit 402, the handover request message includes a UL forwarding not possible parameter, and the UL forwarding not possible parameter is used for indicating that the target node RN does not need to forward the uplink data of which radio access bearer (RAB); and after the target node RN receives this parameter, the RN knows that an uplink data forwarding tunnel identity does not need to be allocated to the uplink data of which RAB. The UL forwarding not possible parameter is similar to the definition of a Data forwarding not possible parameter of the handover request message in the S1 handover scenario, except that the Data forwarding not possible parameter included in S1 handover signaling indicates that the uplink and downlink data of which RAB of the UE does not need to be forwarded, and the newly added UL forwarding not possible parameter merely indicates that the uplink data of which RAB of the UE does not need to be forwarded. If the scenario of the embodiment of the present invention is an X2 handover scenario, the handover request message uses a signaling structure of an X2 interface; and if the scenario of the embodiment of the present invention is an S1 handover scenario, the handover request message uses a signaling structure of an S1 interface.

In the Inter-eNB handover scenario where the target node is the RN, although the handover request acknowledge message received from the target node RN by the DeNB with the target node attached thereto does not carry the uplink data forwarding tunnel identity allocated by the target node RN in the embodiment of the present invention, the handover request acknowledge message returned from the DeNB to an MME needs to carry the uplink data forwarding tunnel identity allocated by the DeNB. Further, in this scenario, if data are forwarded in a direct forwarding mode, a handover command message received by a source node carries an uplink data forwarding tunnel identity allocated by the DeNB side, so as to establish an uplink data forwarding tunnel from the source node to the DeNB; if data are forwarded in an indirect forwarding mode, the handover command message received by the source node carries an uplink data forwarding tunnel identity allocated by an S-GW side, so as to establish an uplink data forwarding tunnel from the source node to the S-GW.

In the uplink data forwarding process, it should be noted that, the uplink data forwarding tunnel identity allocated by the DeNB and the uplink data forwarding tunnel identity allocated by the target node RN are different, wherein the uplink data forwarding tunnel identity allocated by the target node RN is used for forwarding the uplink data from the DeNB to the target node RN and establishing a forwarding tunnel from the DeNB to the target node RN; and the uplink data forwarding tunnel identity allocated by the DeNB is used for forwarding the uplink data from the source node to the DeNB and establishing a forwarding tunnel directly from the source node to the DeNB (aiming at a direct data forwarding mode), or forwarding the uplink data from the S-GW to the DeNB and establishing a forwarding tunnel from the S-GW to the DeNB (aiming at an indirect data forwarding mode).

III, alternatively, in the handover preparation process, after the handover request message is sent to the RN, if the handover request message does not carry the first IE identity or the UL forwarding not possible parameter, the handover request acknowledge message sent by the RN may also be received by the request acknowledge receiving module 4022 of the handover preparation unit 402; and in practical application, after the target node RN receives the handover request message and determines itself as the target node in handover, the RN does not allocate an uplink data forwarding tunnel identity. When the target node RN returns the handover request acknowledge message to the above-mentioned DeNB, the handover request acknowledge message does not carry any uplink data forwarding tunnel identity but carries a second IE identity, wherein the second IE identity is used for indicating a decision by the donor evolved NodeB that whether a source node is needed to forward the uplink data, namely decide that the uplink data of which RAB needs to be forwarded and allocate an uplink data forwarding tunnel identity to the RAB.

After the DeNB acquires the second IE identity, according to the indication of the above-mentioned second IE identity, the identity allocating module 4024 of the handover preparation unit 402 decides that the uplink data corresponding to which RAB needs to be forwarded, and allocates a corresponding uplink data forwarding tunnel identity (the uplink data forwarding tunnel identity may be a UL GTP TEID in an X2 handover scenario or a UL transport layer address and a UL GTP-TEID in an S1 handover scenario) to the RAB. Alternatively, the DeNB may actively decide the allocation of an uplink data forwarding tunnel identity, at this moment, the handover request message sent from the target node RN to the DeNB may not carry the above-mentioned second IE identity; specifically, after the DeNB receives the handover request acknowledge message sent by the target node RN, no matter whether the handover request acknowledge message carries the uplink data forwarding tunnel identity allocated by the target node RN, the identity allocating module 4024 re-decides that the uplink data of which RAB of the UE needs to be forwarded and reallocates the corresponding uplink data forwarding tunnel identity to the RAB needing forwarding of the uplink data.

IV, alternatively, after the request acknowledge receiving module 4022 receives the handover request acknowledge message sent by the RN, if the handover request acknowledge message carries an uplink data forwarding tunnel identity, the identity modifying module 4025 modifies the carried uplink data forwarding tunnel identity allocated by the target node into an uplink data forwarding tunnel identity allocated by the DeNB. In the case of the X2 handover scenario, the updated handover request acknowledge message is directly sent to the source node; and in the case of the S1 handover scenario, the updated handover request acknowledge message is sent to an MME, and the MME forwards the handover request acknowledge message to the source node, so that the source node sends the uplink data according to the uplink data forwarding tunnel identity allocated by the DeNB.

The transfer message sending unit 403 sends the SN status transfer message to the RN; and the SN status transfer message may be used for transferring receiving status information of the uplink data sent by the UE in the source node in handover to the RN.

After the SN status transfer message is sent to the RN, the data sending unit 404 directly sends the uplink data received from the UE to the S-GW.

Since the DeNB knows that the target node in handover is the RN attached to the DeNB, the DeNB will ignore the constraint of stopping sending the uplink data to the S-GW in the prior art, does not forward the cached uplink data to the RN and directly sends the cached uplink data to the S-GW, and thus avoiding the resource waste caused by the repeated transmission of the uplink data between the DeNB and the RN.

The methods for forwarding uplink data provided in the present invention may be applied to an Intra-eNB handover scenario and an Inter-eNB handover scenario.

In the Intra-eNB handover scenario where the target node is the RN: the source node may be the DeNB, and after the DeNB instructs the UE to perform handover, the DeNB sends the SN status transfer message to the RN. Or, the source node may also be other RN attached to the DeNB; after the RN serving as the source node instructs the UE to perform handover, the RN serving as the source node sends the SN status transfer message to the DeNB; and after the DeNB receives the SN status transfer message, the DeNB may transfer the SN status transfer message to the target node RN.

If the source node is the DeNB, before the UE performs handover, the DeNB sends the uplink data sent by the UE to the S-GW, and the uplink data may be a service data unit (SDU) of an uplink packet data convergence protocol (PDCP). If the source node is another RN attached to the DeNB, before the UE performs handover, the DeNB sends the uplink data received from the source node to the S-GW. After the DeNB sends the SN status transfer message to the target node, since the DeNB knows that the target node in handover is the RN attached to the DeNB, at this moment, the DeNB continuously sends the received uplink data to the S-GW and does not forward the uplink data to the target node.

In the Inter-eNB handover scenario where the target node is the RN, when the source node instructs the UE to perform handover, the source node may send the SN status transfer message; and after the DeNB with the target node RN attached thereto receives the SN status transfer message, the DeNB may transfer the SN status transfer message to the target node RN. Wherein, the source node may be an eNB, a neighboring DeNB or an RN attached to the neighboring DeNB.

After the source node instructs the UE to perform handover, the source node sends the SN status transfer message; and after the DeNB with the target node RN attached thereto receives the SN status transfer message, the DeNB sends the SN status transfer message to the target node RN. After the DeNB with the target node RN attached thereto sends the SN status transfer message to the target node RN, since the DeNB knows that the target node in handover is the RN attached to the DeNB, the DeNB directly sends the uplink data received from the source node to the S-GW and does not send the uplink data received from the source node to the target node RN.

In the embodiment of the present invention, since the DeNB knows that the target node in handover is the RN attached to the DeNB, after the DeNB sends the SN status transfer message to the RN, even if the RN sends an uplink data forwarding tunnel identity (the uplink data forwarding tunnel identity is used for indicating a channel used for forwarding the uplink data) to the DeNB in the handover preparation process, the DeNB also ignores the received uplink data forwarding tunnel identity, does not establish an uplink data forwarding tunnel from the DeNB to the RN and directly sends the received uplink data to the S-GW, thus saving overhead of the repeated transmission of the uplink data between the DeNB and the RN. Wherein, the uplink data forwarding tunnel identity may be a tunnel endpoint identity (TEID) of an uplink general packet radio service (GPRS) tunnel protocol (UL GTP) in an X2 handover scenario or a UL transport layer address and a UL GTP TEID in an S1 handover scenario.

In the several embodiments provided in the application, it should be understood that, the disclosed device and method may be realized in other mode. For example, the embodiments of the above-described device are merely exemplary. For example, division of the units is merely a logic function division, other division mode may be adopted in practice, e.g., multiple units or components may be combined or integrated in another system, or some characteristics may be omitted or not executed. From another point of view, the displayed or discussed mutual coupling or direct coupling or communication connection may be indirect coupling or communication connection of devices or units through some interfaces, and may also be in electrical, mechanical or other form.

The units illustrated as separate components may be or may not be physically separated, and the components displayed as units may be or may not be physical units, that is to say, the components may be positioned at one place or may also be distributed on multiple network units. The objectives of the solutions of the embodiments may be fulfilled by selecting part of or all of the units according to actual needs.

In addition, in various embodiments of the present invention, the functional units may be integrated in one processing unit, or the functional units may separately and physically exist, or two or more units may be integrated in one unit. The above-mentioned integrated unit may be realized in the form of hardware or a software functional unit.

When the integrated unit is realized in the form of the software functional unit and sold or used as an independent product, the integrated unit may be stored in a computer-readable storage medium. Based on such an understanding, the technical solution of the present invention substantially, or the part of the present invention making contribution to the prior art, or all of or part of the technical solution may be embodied in the form of a software product, and the computer software product is stored in a storage medium, which includes multiple instructions enabling computer equipment (which may be a personal computer, a server, network equipment or the like) to execute all of or part of the steps in the methods of the embodiments of the present invention. The above-mentioned storage medium includes: various media capable of storing program codes, such as U disk, mobile hard disk, read-only memory (ROM), random access memory (RAM), magnetic disk, optical disk or the like.

The foregoing descriptions are merely preferred specific embodiments of the present invention, rather than limiting the protection scope of the present invention. Any skilled who is familiar with this art could readily think of variations or substitutions within the disclosed technical scope of the present invention, and these variations or substitutions should fall into the protection scope of the present invention. Therefore, the protection scope of the present invention shall be defined by the claims.

What is claimed is:

1. A method for forwarding uplink data, comprising:
receiving, by a donor base station, uplink data sent by a user equipment, wherein a relay node (RN) is attached to the donor base station and the RN is a target node in handover;
performing, by the donor base station, a handover preparation with the relay node (RN) to handover the user equipment from a source node to the RN;
sending, by the donor base station, a serial number status transfer message to the RN, wherein the serial number status transfer message is used for indicating receiving status information of the uplink data received by the source node; and
sending, by the donor base station, the received uplink data sent by the user equipment to a serving-gateway (S-GW) after sending the serial number status transfer message to the RN.

2. The method according to claim 1, wherein the performing, by the donor base station, a handover preparation with the RN, comprising: sending, by the donor base station, a handover request message to the RN, wherein the handover request carries a first information element (IE) identity, and the first IE identity is used for indicating that the RN does not need to allocate an uplink data forwarding tunnel identity.

3. The method according to claim 1, wherein the performing, by the donor base station, the handover preparation with the RN, comprising: receiving, by the donor base station, a handover request acknowledge message sent by the RN, wherein the handover request acknowledge message carries a second IE identity, and the second IE identity is used for indicating a decision by the donor evolved NodeB that whether a source node is needed to forward the uplink data.

4. The method according to claim 1, wherein the performing, by the donor base station, a handover preparation with the RN, comprises:
sending, by the donor base station, a handover request message to the RN, wherein the handover request message carries an uplink forwarding not possible parameter of a radio access bearer of the UE, and the uplink forwarding not possible parameter is utilized to indicate that the RN does not need to forward the uplink data of the radio access bearer.

5. The method according to claim 1, wherein the performing, by the donor base station, a handover preparation with the RN, further comprises:
receiving, by the donor base station, a handover request acknowledge message sent by the target node RN; re-deciding, by the donor base station, which radio access bearer (RAB) of the UE needs a forwarding of the uplink data no matter whether the handover request acknowledge message carries an uplink data forwarding tunnel identity allocated by the RN; and
reallocating, by the donor base station, a corresponding uplink data forwarding tunnel identity to the RAB needing a forwarding of the uplink data.

6. The method according to claim 1, wherein the performing, by the donor base station, a handover preparation with the RN, further comprising:
receiving, by the donor base station, a handover request acknowledge message sent by the target node RN;
when the handover request acknowledge message carries an uplink data forwarding tunnel identity corresponding to a RAB of the UE, modifying by the donor base station, the uplink data forwarding tunnel identity into an uplink data forwarding tunnel identity which is allocated by the donor base station.

7. A donor base station, comprising at least a processor with circuitry operating in conjunction with at least a memory, wherein the at least one memory stores codes implemented as a plurality of units, the plurality of units comprise:
a data receiving unit, which causes uplink data sent by a user equipment to be received;
a handover preparation unit, which causes a handover preparation to be performed with a relay node (RN) to handover the user equipment from a source node to the RN, wherein the RN is a target node in handover and the RN is attached to the donor base station;
a transfer message sending unit, which causes a serial number status transfer message to be sent to the RN, wherein the serial number status transfer message is used for indicating receiving status information of the uplink data received by the source node;
a data sending unit, which causes the received uplink data sent by the user equipment to be sent to a serving-gateway after the serial number status transfer message is sent to the RN.

8. The donor base station according to claim 7, wherein the handover preparation unit comprises:
a first request sending module, which causes a handover request message to be sent to the RN, wherein the handover request carries a first information element (IE) identity, and the first IE identity is used for indicating that the RN does not need to allocate an uplink data forwarding tunnel identity.

9. The donor base station according to claim 7, wherein the handover preparation unit further comprises:
a request acknowledge receiving module, which causes a handover request acknowledge message returned by the RN to be received, wherein the handover request acknowledge message carries a second IE identity, and the second IE identity is used for indicating a decision by the donor evolved NodeB that whether a source node is needed to forward the uplink data.

10. The donor base station according to claim 7, wherein the handover preparation unit further comprises:
a second request sending module, which causes a handover request message to be sent to the RN, wherein the handover request message carries an uplink forwarding not possible parameter of a radio access bearer of the UE, and the uplink forwarding not possible parameter is used for indicating that the RN does not need to forward the uplink data of the radio access bearer.

11. The donor base station according to claim 9, wherein the handover preparation unit further comprises:
an identity allocating module, which causes which radio access bearer (RAB) of the UE needs a forwarding of the uplink data to be re-decided no matter whether the handover request acknowledge message carries an uplink data forwarding tunnel identity allocated by the RN, after the handover request acknowledge message sent by the target node RN is received, and causes a corresponding uplink data forwarding tunnel identity to be reallocated to the RAB needing a forwarding of the uplink data.

12. The donor base station according to claim 11, wherein,
the request acknowledge receiving module further causes whether the handover request acknowledge message carries the uplink data forwarding tunnel identity corresponding to the RAB of the UE to be detected after the handover request acknowledge message sent by the target node RN is received, and causes an identity modifying module to be triggered when the handover request acknowledge message carries the uplink data forwarding tunnel identity;
the handover preparation unit further comprises: the identity modifying module, which, when the handover request acknowledge message carries the uplink data forwarding tunnel identity corresponding to the RAB of the UE, causes the uplink data forwarding tunnel identity to be modified into the allocated uplink data forwarding tunnel identity.
